(19) United States
(12) Patent Application Publication
(10) Pub. No.: US 2014/0351151 A1
(43) Pub. Date: Nov. 27, 2014

(54) PROVIDING A LEASE PERIOD DETERMINATION

(71) Applicant: INTERNATIONAL BUSINESS MACHINES CORPORATION, Armonk, NY (US)

(72) Inventors: Lawrence Y. CHIU, Saratoga, CA (US); Paul H. MUENCH, San Jose, CA (US); Sangeetha SESHADRI, Vancouver, WA (US)

(73) Assignee: INTERNATIONAL BUSINESS MACHINES CORPORATION, Armonk, NY (US)

(21) Appl. No.: 13/901,369

(22) Filed: May 23, 2013

(51) Int. Cl. G06Q 30/06

(52) U.S. Cl. CPC G06Q 30/0645
USPC 705/307

(57) ABSTRACT

An optimal lease period of data is determined for each client by a centralized entity by using a variety of factors. The variety of factors include at least access characteristics of the data, historical access patterns of the data, and system configurations and policies.

### BACKGROUND OF THE INVENTION

1. Field of the Invention

The present invention relates in general to computers, and more particularly to providing a lease period determination in a computing storage environment.

2. Description of the Related Art

In today's society, computer systems are commonplace. Computer systems may be found in the workplace, at home, or at school. Computer systems may include data storage systems, or disk storage systems, to process and store data. In recent years, both software and hardware technologies have experienced amazing advancement. Data storage systems, or disk storage systems, are utilized to process and store data. A storage system may include one or more disk drives. These data processing systems typically require a large amount of data storage. Customer data, or data generated by users within the data processing system, occupies a great portion of this data storage. Many of these computer systems include physical and virtual storage components. Processing very large amounts of information is a key problem to solve, and therefore, a need exists to improve computing efficiency and providing a lease period determination of data.

### SUMMARY OF THE DESCRIBED EMBODIMENTS

In one embodiment, a method is provided for providing a lease period determination by a processor device in a computing storage environment. An optimal lease period of data is determined for each client by a centralized entity by using a variety of factors. The variety of factors include at least access characteristics of the data, historical access patterns of the data, and system configurations and policies.

In another embodiment, a computer system is provided for providing a lease period determination by a processor device in a computing storage environment. The computer system includes a computer-readable medium and a processor in operable communication with the computer-readable medium. The processor determines an optimal lease period of data for each client by a centralized entity by using a variety of factors. The variety of factors include at least access characteristics of the data, historical access patterns of the data, and system configurations and policies.

In a further embodiment, a computer program product is provided for providing a lease period determination by a processor device in a computing storage environment. The computer-readable storage medium has computer-readable program code portions stored thereon. The computer-readable program code portions include a first executable portions that determines an optimal lease period of data for each client by a centralized entity by using a variety of factors. The variety of factors include at least access characteristics of the data, historical access patterns of the data, and system configurations and policies.

In addition to the foregoing exemplary method embodiment, other exemplary system and computer product embodiments are provided and supply related advantages. The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 is a block diagram illustrating a computer storage environment having an exemplary storage device in which aspects of the present invention may be realized;

FIG. 2 is a block diagram illustrating a hardware structure of an exemplary data storage system in a computer system in which aspects of the present invention may be realized;

FIG. 3 is a block diagram illustrating distributed caching scheme in which aspects of the present invention may be realized;

FIG. 4 is a flow chart diagram illustrating an exemplary method for providing a lease period determination in which aspects of the present invention may be realized; and

FIG. 5 is a block diagram illustrating access history and sharing model (AHSM) based lease period determining in which aspects of the present invention may be realized.

### DETAILED DESCRIPTION OF THE DRAWINGS

As previously mentioned, computing systems are used to store and manage a variety of types of data. With increasing demand for faster, more powerful and more efficient ways to store information, optimization of storage technologies is becoming a key challenge. Processing very large amounts of information is a key problem to solve, and therefore, a need exists to improve computing efficiency and providing a lease period determination of data. For example, in one embodiment, data may be simultaneously accessed by multiple readers and writers from a central repository that maintains a single consistent copy of the data. In order to minimize the amount of data that needs to be transferred over relatively slower network connections, the readers and writers maintain local copies of the data. However, in order to keep the local copies consistent, the readers and writers need to tightly couple with the server and receive timely information regarding updates to the data that render their local cached content stale. This may be preformed by using a mechanism of leases where the readers/writers are granted permission to cache data provided that they respond and process updates from the server before the lease period expires. However, short lease periods increase the frequency of polling between the clients and the servers while longer lease periods result in increased response time for write requests (which needs to wait till all remote cached content is invalidated). Hence, a need exists to identify an optimal lease period for the caching cluster.

In modern computer system and networking architectures, a computer system that is a repository for data files is typically not the computer system on which processing of the data files is performed. Consequently, a user at a computer workstation associated with a remote site computer system, such as a laptop computer, networked computer or desktop computer, often will desire to access, i.e., view (read) or modify (write), a data file that is stored in an internal memory, on a disk or in network attached storage of a remotely located central data source computer system. Such remote access of data files is performed over a communications channel, such as a data bus, a communications network or the Internet, which typically introduces a delay or latency in the presentation of the data file at the system accessing the data file. The latency is based on the need to transmit data between the system accessing the data file and the system that produces or stores the data file. In addition, the data file is usually accessed in portions or blocks rather than as a continuous stream, which exacerbates the latency because each block experiences the channel delays upon transmission.

In order to mitigate the effects of channel delays, in one embodiment, the computer systems that perform distributed file system applications, which provide for shared access to data files, may implement some form of caching. In caching, a local copy of all or a portion of a data file, which is stored at a central source computer system (e.g., a computer and/or a server), is maintained in a cache established at a remote system, such as in the local memory of a workstation and/or server associated with the remote system. The workstation can read or write to the cached data file, where the cached data file mirrors all or a portion of the data file stored at the central system. The cache also stores data that tracks any changes made to the cached data file, which are entered by the workstation and ultimately are to be incorporated into the data file stored at the file server. Thus, with caching, channel latency can be mitigated and a user of the workstation of the remote system is not aware that the data file is accessed from a local source rather than a remotely located central source system.

In one embodiment, a distributed file system may provide for shared access to data files among a plurality of remote systems, but the caching system that is implemented needs to maintain cache coherence and cache consistency to avoid different versions of a data file being accessed by different respective remote systems. Cache coherence is a guarantee that updates and the order of the updates to a cached data file are preserved and safe. Thus, in one embodiment, a coherent distributed file system, there is a guarantee that (i) a remote system does not delete the cached update data before the update data is used to update the corresponding data file stored at the file server, and (ii) no other system updates the data file in a manner that potentially can compromise the update of the data file until the data file at the server has been updated using the update data from the cache. Cache consistency is a guarantee that the updates to an opened, cached data file made by a workstation are reflected in the cached data file in a timely fashion. The properties of cache coherence and cache consistency are equally important when multiple remote systems access the same data file. In this circumstance, coherence additionally ensures that updates on any cache corresponding to a data file stored at the file server do not override updates by another cache corresponding to the same data file. Cache consistency additionally ensures that updates to the cached data file made at any cache are, in a timely fashion, incorporated into the cached data file at any other cache, which is accessing the same data file.

In one embodiment, a strict-consistency is used in a cooperative caching system (e.g., in the distributed file system) where multiple clients cache data primarily stored at a single central location (e.g., a server). The data may be accessed from a caching client or a non-caching client. A central server collects client access patterns from the caching clients and also gathers local access pattern based on access to non-cached data. Caching decisions are made collectively by the caching clients and the server.

However, in such an environment, a lease mechanism (e.g., a lease period mechanism) may be used and is required to keep track of clients actively caching data, especially in order to ensure that remote write operations result in cache invalidation. Choosing a longer lease period timeout can result in write operations taking much longer to complete but allow longer distance between client and server. Thus the cooperative caching system experiences poor response times. On the other hand, imposing a shorter lease timeout will eliminate slow responding clients (such as remote nodes or heavily loaded nodes in the distributed file system) from caching any data. Also, frequent lease loss at the client may occur and demand high network/processing overhead may also be experienced. Lease loss occurs when the client is unable to respond back to the server before the lease period. This could happen due to the client node being overloaded and not having enough processing resources, or the network connection between the client and the server being slow or faulty. If there is an issue with the network connection, the client may have to retry multiple times before it can successfully communicate with the server. Additionally, components such as device adaptors or drivers or interconnects may fail or not adhere to the protocol imposed timelines. For example, it is observed that some device drivers have to wait nearly a minute before its outstanding communication can even fail. This may also be due to events such as server undergoing failure recovery. The bottom line is that if the lease period is too short, the probability of the client not being able to keep up its side of the contract is higher, resulting in loss of the lease. Lease loss in turn entails cache to be purged. Repopulation could potentially take hours depending on the size of the cache.

Thus, the present invention seeks to provide increased efficiency and computer storage performance, without the limitations experienced by a fixed lease period, relaxed and/or variable lease period, and/or popularity based lease period, etc., by determining an optimal lease period of data for each client by a centralized entity by using a variety of factors. The variety of factors include at least access characteristics of the data, historical access patterns of the data, and system configurations and policies.

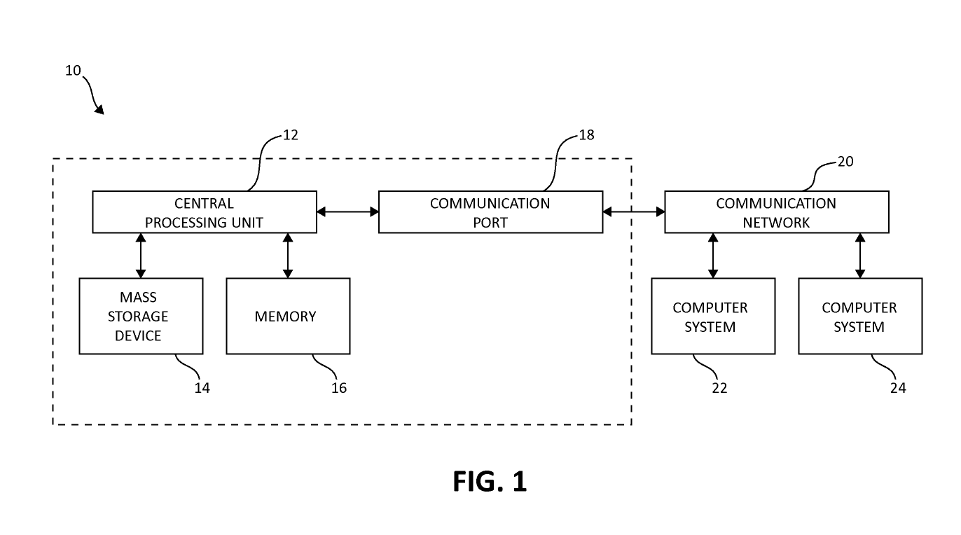

Turning now to FIG. 1, exemplary architecture 10 of data storage systems in a computing environment is depicted. The computer system 10 includes central processing unit (CPU) 12, which is connected to mass storage device(s) 14 and memory device 16. Mass storage devices can include hard disk drive (HDD) devices, solid-state devices (SSD) etc., which can be configured in a redundant array of independent disks (RAID). The backup operations further described can be executed on device(s) 14, located in system 10 or elsewhere. Memory device 16 can include such memory as electrically erasable programmable read only memory (EEPROM) or a host of related devices. Memory device 16 and mass storage device 14 are connected to CPU 12 via a signal-bearing medium. In addition, CPU 12 is connected through communication port 18 to a communication network 20, having an attached plurality of additional computer systems 22 and 24. The computer system 10 may include one or more processor devices (e.g., CPU 12) and additional memory devices 16 for each individual component of the computer system 10.

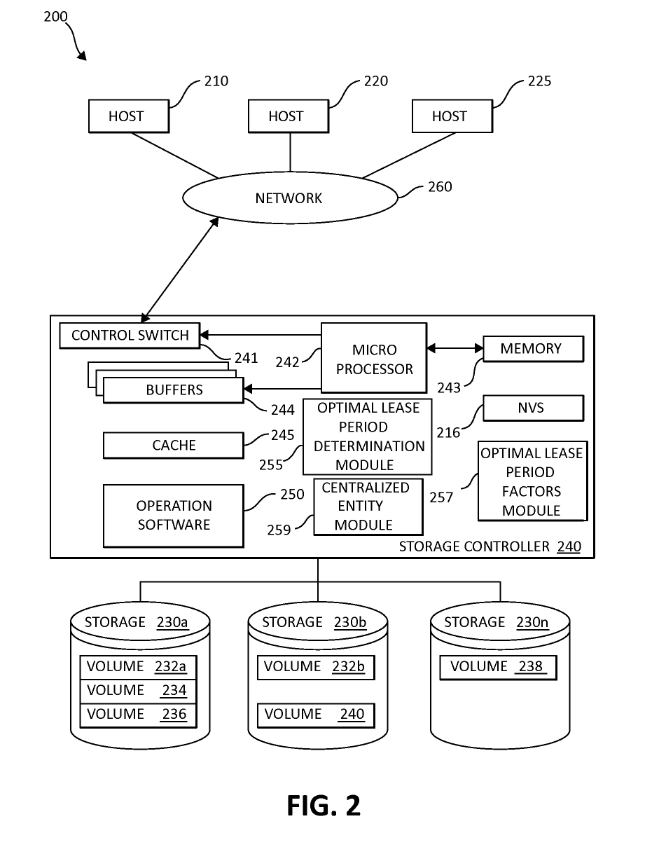

FIG. 2 is an exemplary block diagram 200 showing a hardware structure of a data storage system in a computer system according to the present invention. Referring to FIG. 2, there are shown host computers 210, 220, 225, each acting as a central processing unit for performing data processing a part of a data storage system 200. The hosts (physical or virtual devices), 210, 220, and 225 may be one or more new physical devices or logical devices to accomplish the purposes of the present invention in the data storage system 200. In one embodiment, by way of example only, a data storage system 200 may be implemented as IBM® System Storage™ DS8000™. A network connection 260 may be a fibre channel fabric, a fibre channel point to point link, a fibre channel over ethernet fabric or point to point link, a FICON or ESCON I/O interface, any other I/O interface type, a wireless network, a wired network, a LAN, a WAN, heterogeneous, homogeneous, public (i.e. the Internet), private, or any combination thereof. The hosts, 210, 220, and 225 may be local or distributed among one or more locations and may be equipped with any type of fabric (or fabric channel) (not shown in FIG. 2) or network adapter 260 to the storage controller 240, such as Fibre channel, FICON, ESCON, Ethernet, fiber optic, wireless, or coaxial adapters. Data storage system 200 is accordingly equipped with a suitable fabric (not shown in FIG. 2) or network adapter 260 to communicate. Data storage system 200 is depicted in FIG. 2, and as may be used in FIG. 1, comprising storage controller 240 and storage 230. In one embodiment, the embodiments described herein may be applicable to a variety of types of computing architectures and configuration, such as in a physical and/or virtual cluster management environment using the various embodiments as described herein.

To facilitate a clearer understanding of the methods described herein, storage controller 240 is shown in FIG. 2 as a single processing unit, including a microprocessor 242, system memory 243 and nonvolatile storage (“NVS”) 216, which will be described in more detail below. It is noted that in some embodiments, storage controller 240 is comprised of multiple processing units, each with their own processor complex and system memory, and interconnected by a dedicated network within data storage system 200. Storage 230 may be comprised of one or more storage devices, such as storage arrays, which are connected to storage controller 240 by a storage network.

In some embodiments, the devices included in storage 230 may be connected in a loop architecture. Storage controller 240 manages storage 230 and facilitates the processing of write and read requests intended for storage 230. The system memory 243 of storage controller 240 stores program instructions and data, which the processor 242 may access for executing functions and method steps associated with managing storage 230 and executing the steps and methods of the present invention in a computer storage environment. In one embodiment, system memory 243 includes, is associated, or is in communication with the operation software 250 in a computer storage environment, including the methods and operations described herein. As shown in FIG. 2, system memory 243 may also include or be in communication with a cache 245 for storage 230, also referred to herein as a “cache memory”, for buffering “write data” and “read data”, which respectively refer to write/read requests and their associated data. In one embodiment, cache 245 is allocated in a device external to system memory 243, yet remains accessible by microprocessor 242 and may serve to provide additional security against data loss, in addition to carrying out the operations as described in herein.

In some embodiments, cache 245 is implemented with a volatile memory and non-volatile memory and coupled to microprocessor 242 via a local bus (not shown in FIG. 2) for enhanced performance of data storage system 200. The NVS 216 included in data storage controller is accessible by microprocessor 242 and serves to provide additional support for operations and execution of the present invention as described in other figures. The NVS 216, may also referred to as a “persistent” cache, or “cache memory” and is implemented with nonvolatile memory that may or may not utilize external power to retain data stored therein. The NVS may be stored in and with the Cache 245 for any purposes suited to accomplish the objectives of the present invention. In some embodiments, a backup power source (not shown in FIG. 2), such a battery, supplies NVS 216 with sufficient power to retain the data stored therein in case of power loss to data storage system 200. In certain embodiments, the capacity of NVS 216 is less than or equal to the total capacity of cache 245.

Storage 230 may be physically comprised of one or more storage devices, such as storage arrays. A storage array is a logical grouping of individual storage devices, such as a hard disk. In certain embodiments, storage 230 is comprised of a JBOD (Just a Bunch of Disks) array or a RAID (Redundant Array of Independent Disks) array. A collection of physical storage arrays may be further combined to form a rank, which dissociates the physical storage from the logical configuration. The storage space in a rank may be allocated into logical volumes, which define the storage location specified in a write/read request.

In one embodiment, by way of example only, the storage system as shown in FIG. 2 may include a logical volume, or simply “volume,” may have different kinds of allocations. Storage 230a, 230b and 230n are shown as ranks in data storage system 200, and are referred to herein as rank 230a, 230b and 230n. Ranks may be local to data storage system 200, or may be located at a physically remote location. In other words, a local storage controller may connect with a remote storage controller and manage storage at the remote location. Rank 230a is shown configured with two entire volumes, 234 and 236, as well as one partial volume 232a. Rank 230b is shown with another partial volume 232b. Thus volume 232 is allocated across ranks 230a and 230b. Rank 230n is shown as being fully allocated to volume 238—that is, rank 230n refers to the entire physical storage for volume 238. From the above examples, it will be appreciated that a rank may be configured to include one or more partial and/or entire volumes. Volumes and ranks may further be divided into so-called “tracks,” which represent a fixed block of storage. A track is therefore associated with a given volume and may be given a given rank.

The storage controller 240 may include an optimal lease period determination module 255, an optimal lease period factors module 257, and a centralized entity module 259 in a computer storage environment. The optimal lease period determination module 255, the optimal lease period factors module 257, and the centralized entity module 259 may work in conjunction with each and every component of the storage controller 240, the hosts 210, 220, 225, and storage devices 230. The optimal lease period determination module 255, the optimal lease period factors module 257, and the centralized entity module 259 may be structurally one complete module working together and in conjunction with each other for performing such functionality as described below, or may be individual modules. The optimal lease period determination module 255, the optimal lease period factors module 257, and the centralized entity module 259 may also be located in the cache 245 or other components of the storage controller 240 to accomplish the purposes of the present invention.

The storage controller 240 may be constructed with a control switch 241 for controlling the fiber channel protocol to the host computers 210, 220, 225, a microprocessor 242 for controlling all the storage controller 240, a nonvolatile control memory 243 for storing a microprogram (operation software) 250 for controlling the operation of storage controller 240, data for control and each table described later, cache 245 for temporarily storing (buffering) data, and buffers 244 for assisting the cache 245 to read and write data, a control switch 241 for controlling a protocol to control data transfer to or from the storage devices 230, optimal lease period determination module 255, the optimal lease period factors module 257, and the centralized entity module 259 on which information may be set. Multiple buffers 244 may be implemented with the present invention in a computing environment, or performing other functionality in accordance with the mechanisms of the illustrated embodiments.

In one embodiment, by way of example only, the host computers or one or more physical or virtual devices, 210, 220, 225 and the storage controller 240 are connected through a network adaptor (this could be a fiber channel) 260 as an interface i.e., via a switch sometimes referred to as “fabric.” In one embodiment, by way of example only, the operation of the system shown in FIG. 2 will be described. The microprocessor 242 may control the memory 243 to store command information from the host device (physical or virtual) 210 and information for identifying the host device (physical or virtual) 210. The control switch 241, the buffers 244, the cache 245, the operating software 250, the microprocessor 242, memory 243, NVS 216, the optimal lease period determination module 255, the optimal lease period factors module 257, and the centralized entity module 259 are in communication with each other and may be separate and/or one individual component(s). Also, several, if not all of the components, such as the operation software 245 may be included with the memory 243 in a computer storage environment. Each of the components within the storage device may be linked together and may be in communication with each other for purposes suited to the present invention.

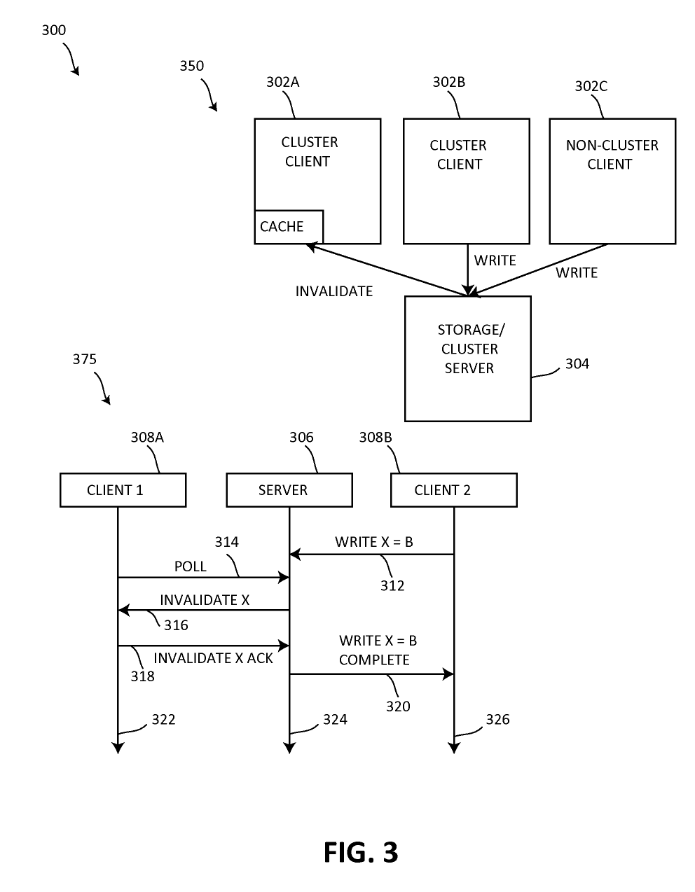

FIG. 3 is a block diagram illustrating distributed caching scheme 300 in which aspects of the present invention may be realized. In FIG. 3 in the upper block 350, three clients 302 (shown in FIG. 3 as cluster client 302A, cluster client 302B, and a non-cluster client 302C) having access to a storage/cluster server 304. Cluster client 302A, cluster client 302B are part of the distributed caching scheme and the non-cluster client 302C is not a part of the distributed caching scheme (e.g., the non-cluster client 302C does not have the operation protocol for operating in the distributed caching scheme and does not have a cache nor follow the caching protocol), but all clients have access to the data within the storage/cluster server 304. In one embodiment, the cluster client 302A is depicted with a cache located in the cluster client 302A and has saved some of the data from the storage/cluster server 304 in the cache. The cluster client 302B and the non-cluster client 302C both issue write operations to the storage/cluster server 304 (as indicated in the FIG. 3 with arrows labeled as “write”).

At this point, the cluster client 302A that has the data saved in cache needs to be informed of the write operations by the cluster client 302B and the non-cluster client 302C, with the protocol for informing generically illustrated, by way of example only in the lower block 375, with client 1 308A (which has cached the data), the server 306, and client 2 308B, which is actually issuing the write operation (e.g., this could be the cluster client 302B and/or the non-cluster client 302C). This is also depicted in the upper block 350 with an arrow pointing from the storage/cluster server 304 to the cache of the cluster client 302A with an “invalidate” message (e.g., invalidate the data in the cache). A time lines 322, 324, and 326 are also illustrated for illustration purposes. As illustrated, when client 2 308B issues the write operation to data location “x”, the server 306 will not let the write operation complete until the server 306 can inform client 1 308A of the impending write operation from client 2 308B. It is also assumed that every nth period of time (e.g., every 15 seconds) client 1 308A will check 314 (poll) with the server 306 of any operations. The server 306 informs client 1 308A that there is an impending write operation and therefore invalidate 316 your cache (e.g., remove the data from the cache). Client 1 308A now returns to the server 306 that the data in the cache is invalidated by sending an invalidated data X cache acknowledgment (invalidate X ACK) message 318. At this point, the server 306 actually sends an acknowledgment 320 to client 2 308B that the write operation to data location “x” is now complete. Data in now complete and data consistency is experienced within the storage system. In one embodiment, polling is the act of renewing the lease. The poll period is the frequency of polling the server. In order for the lease to be valid, the client must poll the server at least once during the lease period, but may choose to do so more frequently. For example, if a lease period of 60 seconds is used, the choice may be made to poll every 5 seconds. The lease is valid for another 60 seconds from the time that the last poll request was received by the server. On the other hand, the choice may be to poll only once every 59 seconds, renewing the lease just as it was about to expire.

However, a problem exists in the example above in the sense that the time and frequency when the client (e.g., client 308A) should perform the polling period for maximum efficiency is unknown. For example, if the client polls the server ever hour than there are write operations that must wait on the polling period and acknowledgment of the write operation that the data in the cache of the client has been invalidated similar to the example used in FIG. 3. On the other hand, if the client polls the server in very short time intervals (e.g., every millisecond) than too much computing resources is consumed and the efficiency of the computing storage environment is significantly reduced. Thus, a “sweet spot” and/or optimal polling period and/or optimal lease period of data must be determined. In this way, the write operations are not significantly delayed, since the write is dependent upon the poll period based on at least one poll period being required to be completed prior to the write operation completing.

In one embodiment, a fixed lease period may be used where the lease period is pre-determined based on network delays and protocol requirements. With a fixed lease period, the lease period is determined independent of access pattern of data being cached and no selective caching is allowed. Thus, the distributed file system (including the clients and nodes) is required to follow the fixed lease period. In an alternative embodiment, the distributed file system may use a relaxed consistency where the lease period where a relaxed and/or variable lease period is used at the cost of consistency. In other words, the write operation may not be tied to a poll period so it may complete independent of the poll period and the poll periods completing at their own pace.

However, strict consistency is then compromised since strict consistency is a minimum requirement for a storage cache and since the storage system guarantee is a single consistent copy of the data. Thus, the client caching data may be caching stale date that has been subsequently updated in the server. In an alternative embodiment, the distributed file system may use a popularity-based lease in world wide web (WWW) proxies. The distributed file system assigns a long lease period for “popular” objects. The popularity-based lease period does not take into account the nature of access (i.e. read only or write) and may result in long leases for popular write-only data resulting in increased response time. Also, the popularity-based lease period does not take into account system configuration (such as a shared nothing or a shared-access model) or service-level agreements.

Thus, the present invention seeks to provide increased efficiency and computing storage performance, without the limitations experienced by the fixed lease period, relaxed and/or variable lease period, and/or popularity based lease period, etc., by determining an optimal lease period of data for each client by a centralized entity by using a variety of factors. The variety of factors include at least access characteristics of the data, historical access patterns of the data, and system configurations and policies.

In one embodiment, data elements are associated with a lease period that is determined by a centralized entity based on at least one (e.g., one factor and/or multiple factors) and/or a combination of following factors. 1) Policy-driven service level agreements (SLA) settings for response time. For example one policy may mandate a response time (e.g., less than 30 milliseconds “msec”) for “hot data” (e.g., frequently accessed data and/or data that is accessed more frequently than other data) and a response time for archived cold data (e.g., infrequently accessed data and/or data that is accessed less frequently than other data) that is less than one second (e.g., <1 second). 2) Historical Data Access Patterns. The historical data access patterns illustrate and/or determine whether the data is “Hot” (frequently accessed) or “Cold” (infrequently accessed) and/or illustrate and/or determine whether the data is a read and/or a write access. 3) System Configuration Information. The system configuration information illustrates and/or determines whether the data is in a shared access configuration and/or a share-nothing model (e.g., a shared model that shows the “shared access/share nothing configurations). In other words, the shared access allows one or more clients to share access to the data that may be stored (e.g., stored in a server connected to the one or more clients) and the share nothing access configuration prohibits one or more clients from sharing access to the data that may be stored (e.g., stored in a server connected to the one or more clients). In one embodiment, the clients may be a cluster clients and non-cluster clients.

In one embodiment, a lease period for data (LPD) is determined and may be a calculation function. The function may include the historical access pattern of the data desired to be cached (i.e., hot/cold, read/write, number of invalidates), the determined SLA based on a policy setting, and a sharing model (e.g., the shared access/shared nothing configuration). Alternatively, the sharing model can be deduced based on number and frequency of invalidates.

In one embodiment, lease period of node (LPN) is determined and the LPN is equal to the minimum of all the LPDs associated with a node in the distributed file system. A data model can change from one access pattern to another. For example, assume that the data was accessed using a read-only pattern and not so frequently. Based on this access pattern, a lease period of 60 seconds may be selected (or other lease period of time). Then the access pattern changes and the data is now experiencing frequent reads and writes. In order to provide a good response time to the write requests, the lease period now needs to be reduced (e.g., reducing, for example, to 30 seconds). In that event, data suffers decreased performance only until the classification is corrected. Based on the above example, a correction of the lease period is required to improve performance. In one embodiment, one approach is to revoke the permissions of the clients currently caching the data. The clients then need to re-request the permissions and that would reset the expected lease time for the data unit to be 30 seconds.

In one embodiment, for caching data with multiple clients, the “lease period” is established as the timing requirements for communication involving the data. The present invention sets and/or resets the lease periods with a function based on access history (hot/cold, read and/or write “R/W”) and configuration (sharing or not sharing). In one embodiment, the present invention provides data access history and a system configuration based lease period determination in a storage server cache by determining a lease period of a data element that is determined by a centralized entity based on multiple and/or a combination of the factors (such as the policy-driven SLA settings for response times, historical data access pattern, and computing storage configuration information with shared access or share-nothing model).

In one embodiment, the present invention provides the access history and system configuration based lease period determination in a storage server cache based on the following components: 1) a data access history (i.e. hot/cold, R/W) component, 2) configuration setting component (can be implemented as function of invalidates), and 3) a desired lease period component.

Thus, in one embodiment, the lease period may be determined in a data-centric manner based on the different access characteristics of the data entity, policy settings and system configuration settings. In one embodiment, the lease period may be determined (e.g., for a single client and/or multiple clients) based on data access history, policy and configuration thereby addressing the issue of reducing network overhead and meeting service level agreements (SLAs) by determining optimal lease periods.

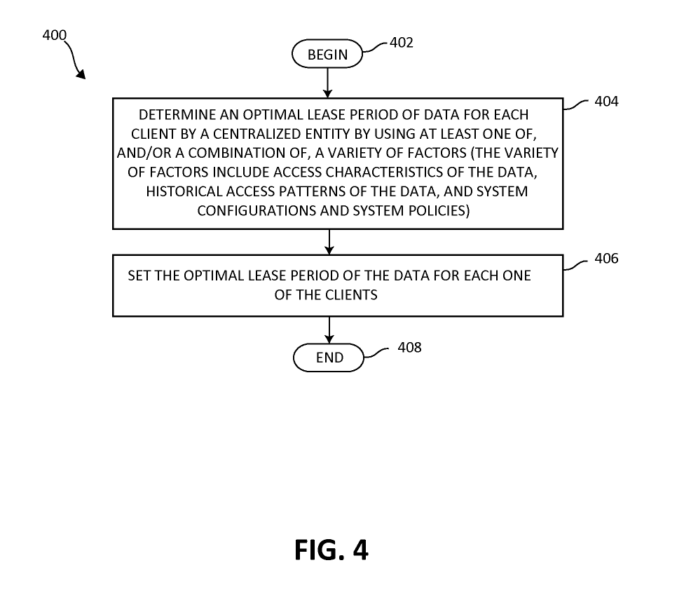

Turning now to FIG. 4, a flow chart diagram illustrating an exemplary method 400 for providing a lease period determination in which aspects of the present invention may be realized is illustrated. The method 400 determines an optimal lease period of data for each client by a centralized entity by using at least one of, and/or a combination of a variety of factors (step 404). The variety of factors may include at least historical access patterns of the data, system configurations, and/or system policies. Also, the access characteristics of the data may also be considered. The method 400 sets the optimal lease period of the data each one of the clients (step 406). The method 400 ends (step 408).

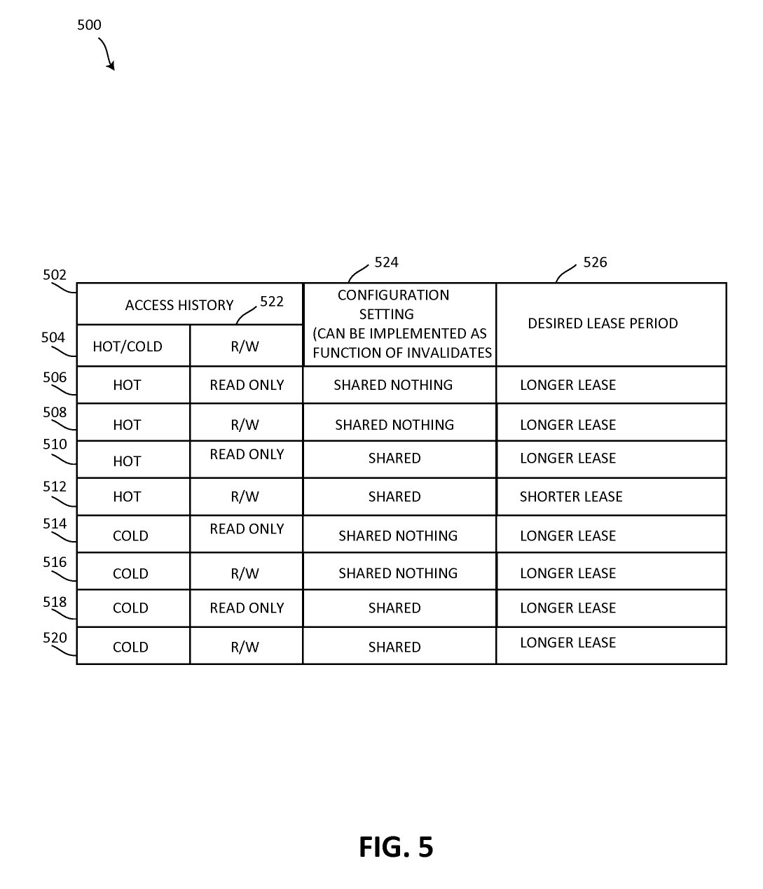

FIG. 5 is a block diagram 500 illustrating access history and sharing model (AHSM) based lease period determining in which aspects of the present invention may be realized. As illustrated in FIG. 5, the access history is illustrated in column 502 and is broken down into illustrating whether the data access history is for “hot” data 504 (e.g., frequently accessed data) and or “cold” data 504 (e.g., infrequently accessed data) and also whether the access to the data is a read access and/or a read and/or write access (RW) 522. The second column in the matrix table 500 shows a second column 524 with the type of configuration (shared configuration and/or a shared-nothing configuration) of the computing storage system and the configuration setting, which may be implemented as a function of invalidates). The third column 526 indicates the desired lease period. The desired lease period (which is the optimal lease period) may be a longer lease period which may be a predetermined time period and is longer than a shorter lease period, which may also be a predetermined time period).

As illustrated in the matrix table 500, the optimal lease period may be determined and set based on the access history 502 and the configuration setting, and the optimal lease period that is set is shown as the desired lease period 526.

As illustrated in row 506, a longer lease period is the optimal lease period for data that is frequently accessed (e.g., hot) and has only a read only access and a shared-nothing configuration. In other words, the lease period may be determined using response times expected based on service level agreements (SLAs). For example, users may require requests to complete within “X” milliseconds or impose a penalty (e.g., impose a penalty on the service provider for not having met the guarantee). As illustrated in row 508, a longer lease period is the optimal lease period for data that is frequently accessed (e.g., hot) and has a read and write (R/W) access and a shared-nothing configuration. As illustrated in row 510, a longer lease period is the optimal lease period for data that is frequently accessed (e.g., hot) and has only a read only access and a shared configuration. As illustrated in row 512, a shorter lease period is the optimal lease period for data that is frequently accessed (e.g., hot) and has a read and write (R/W) access and a shared configuration. As illustrated in row 514, a longer lease period is the optimal lease period for data that is infrequently accessed (e.g., cold) and has only a read only access and a shared-nothing configuration. As illustrated in row 516, a longer lease period is the optimal lease period for data that is infrequently accessed (e.g., cold) and has a read and write (R/W) access and a shared-nothing configuration. As illustrated in row 518, a longer lease period is the optimal lease period for data that is infrequently accessed (e.g., cold) and has only a read only access and a shared configuration. As illustrated in row 520, a longer lease period is the optimal lease period for data that is infrequently accessed (e.g., cold) and has a read and write (R/W) access and a shared configuration.

In one embodiment, an optimal lease period of data is determined for each client by a centralized entity by using at least one, and/or a combination of, a variety of factors. The variety of factors include access characteristics of the data, historical access patterns of the data, and system configurations and policies. The optimal lease period of the data may be set and reset for the one of the plurality of clients. For determining the optimal lease period of the data, historical access patterns of the data is determined, including determining whether the historical access patterns for the data is frequently accessed and/or infrequently accessed, and whether the historical access patterns for the data is read only access and/or read and write access (R/W) for each determination of whether the historical access patterns of the data is one of frequently accessed and infrequently accessed. In one embodiment, for determining the optimal lease period of the data, the present invention uses service level agreements (SLAs) that are included in the system configurations and system policies. The present invention also determines whether the system configuration is a shared configuration and/or a non-sharing configuration (e.g., shared nothing configuration model). In one embodiment, the system configuration sharing model (e.g., whether the configuration shares or does not share access to the data) based on a number of invalidates and a frequency of invalidates.

In one embodiment, the present invention may adjust, on the fly (e.g., rapidly and/or instantly), the optimal lease period for each client. In one embodiment, the present invention may adjust, on the fly (e.g., rapidly and/or instantly), to a new optimal lease period of the data that is determined for each one of the clients based on a change to one or more of the variety of factors used for determining the optimal lease period for one or more of the clients.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the above figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for providing a lease period determination by a processor device in a computing storage environment, the method comprising:
determining an optimal lease period of data for each one of a plurality of clients by a centralized entity by using at least one of a plurality of factors, wherein the plurality of factors include at least one of access characteristics of the data, historical access patterns of the data, a plurality of system configurations and policies; and
setting the optimal lease period of the data for the one of the plurality of clients.

2. The method of claim 1, further including performing one of:
resetting the optimal lease period of the data for the one of the plurality of clients, and
using a combination of the plurality of factors for determining the optimal lease period of the data of the data.

3. The method of claim 1, further including performing each of:
determining whether the historical access patterns of the data is one of frequently accessed and infrequently accessed, and
determining whether the historical access patterns of the data is one of read only access and read and write access for each determination of whether the historical access patterns of the data is one of frequently accessed and infrequently accessed.

4. The method of claim 1, further including performing one of:
using service level agreements (SLAs) in the plurality of system configurations and policies,
determining whether a system configuration is one of a sharing configuration and a non-sharing configuration for including in the plurality of system configurations and policies, and
determining the system configuration is one of the sharing configuration and the non-sharing configuration based on a number of invalidates and a frequency of invalidates.

5. The method of claim 1, further including performing one of:
setting the optimal lease period of the data to be a longer lease period if the plurality of factors indicate that the historical access patterns of the data is frequently accessed and read only, and the plurality of system configurations and policies indicate a non-sharing configuration, wherein the longer lease period is a predetermined lease time,
setting the optimal lease period of the data to be the longer lease period if the plurality of factors indicate that the historical access patterns of the data is frequently accessed and read and write access, and the plurality of system configurations and policies indicate the non-sharing configuration,
setting the optimal lease period of the data to be the longer lease period if the plurality of factors indicate that the historical access patterns of the data is frequently accessed and read only access, and the plurality of system configurations and policies indicate a sharing configuration,
setting the optimal lease period of the data to be a shorter lease period if the plurality of factors indicate that the historical access patterns of the data is frequently accessed and the read and write access, and the plurality of system configurations and policies indicate the sharing configuration, wherein the shorter lease period is a predetermined lease time that is less than the longer lease time,
setting the optimal lease period of the data to be the longer lease period if the plurality of factors indicate that the historical access patterns of the data is infrequently accessed and the read only access, and the plurality of system configurations and policies indicate the non-sharing configuration, wherein the longer lease period is a predetermined lease time,
setting the optimal lease period of the data to be the longer lease period if the plurality of factors indicate that the historical access patterns of the data is the infrequently accessed and the read and write access, and the plurality of system configurations and policies indicate the non-sharing configuration,
setting the optimal lease period of the data to be the longer lease period if the plurality of factors indicate that the historical access patterns of the data is the infrequently accessed and the read only access, and the plurality of system configurations and policies indicate the sharing configuration, and
setting the optimal lease period of the data to be a shorter lease period if the plurality of factors indicate that the historical access patterns of the data is the infrequently accessed and the read and write access, and the plurality of system configurations and policies indicate the sharing configuration.

6. The method of claim 1, further including performing one of:
adjusting the optimal lease period of the data for each one of a plurality of clients based on a change to the at least one of the plurality of factors, and
adjusting on the fly to the optimal lease period for each one of the plurality of clients.

7. The method of claim 1, further including determining an optimal lease period for a node based on a minimum number of optimal lease periods of the data.

8. A system for providing a lease period determination in a computing storage environment, the system comprising:
a cache;
a storage system in association with the cache;
a plurality of nodes operable in the storage system;
a plurality of clients in association with the storage system;
a centralized entity operable in the storage system and in communication with the cache, the plurality of clients, and the plurality of nodes; and
at least one processor device operable in the storage system and in communication with the cache, the node, and the centralized entity, wherein the at least one processor device:
determines an optimal lease period of data for each one of the plurality of clients by a centralized entity by using at least one of a plurality of factors, wherein the plurality of factors include at least one of access characteristics of the data, historical access patterns of the data, a plurality of system configurations and policies, and
sets the optimal lease period of the data for the one of the plurality of clients.

9. The system of claim 8, wherein the at least one processor device performs one of:
resetting the optimal lease period of the data for the one of the plurality of clients, and
using a combination of the plurality of factors for determining the optimal lease period of the data of the data.

10. The system of claim 8, wherein the at least one processor device performs one of:
determining whether the historical access patterns of the data is one of frequently accessed and infrequently accessed, and
determining whether the historical access patterns of the data is one of read only access and read and write access for each determination of whether the historical access patterns of the data is one of frequently accessed and infrequently accessed.

11. The system of claim 8, wherein the at least one processor device performs one of:
using service level agreements (SLAs) in the plurality of system configurations and policies,
determining whether a system configuration is one of a sharing configuration and a non-sharing configuration for including in the plurality of system configurations and policies, and
determining the system configuration is one of the sharing configuration and the non-sharing configuration based on a number of invalidates and a frequency of invalidates.

12. The system of claim 8, wherein the at least one processor device performs one of:
setting the optimal lease period of the data to be a longer lease period if the plurality of factors indicate that the historical access patterns of the data is frequently accessed and read only, and the plurality of system configurations and policies indicate a non-sharing configuration, wherein the longer lease period is a predetermined lease time,
setting the optimal lease period of the data to be the longer lease period if the plurality of factors indicate that the historical access patterns of the data is frequently accessed and read and write access, and the plurality of system configurations and policies indicate the non-sharing configuration,
setting the optimal lease period of the data to be the longer lease period if the plurality of factors indicate that the historical access patterns of the data is frequently accessed and read only access, and the plurality of system configurations and policies indicate a sharing configuration,
setting the optimal lease period of the data to be a shorter lease period if the plurality of factors indicate that the historical access patterns of the data is frequently accessed and the read and write access, and the plurality of system configurations and policies indicate the sharing configuration, wherein the shorter lease period is a predetermined lease time that is less than the longer lease time,
setting the optimal lease period of the data to be the longer lease period if the plurality of factors indicate that the historical access patterns of the data is infrequently accessed and the read only access, and the plurality of system configurations and policies indicate the non-sharing configuration, wherein the longer lease period is a predetermined lease time,
setting the optimal lease period of the data to be the longer lease period if the plurality of factors indicate that the historical access patterns of the data is the infrequently accessed and the read and write access, and the plurality of system configurations and policies indicate the non-sharing configuration,
setting the optimal lease period of the data to be the longer lease period if the plurality of factors indicate that the historical access patterns of the data is the infrequently accessed and the read only access, and the plurality of system configurations and policies indicate the sharing configuration, and
setting the optimal lease period of the data to be a shorter lease period if the plurality of factors indicate that the historical access patterns of the data is the infrequently accessed and the read and write access, and the plurality of system configurations and policies indicate the sharing configuration.

13. The system of claim 8, wherein the at least one processor device performs one of:
adjusting the optimal lease period of the data for each one of a plurality of clients based on a change to the at least one of the plurality of factors, and
adjusting on the fly to the optimal lease period for each one of the plurality of clients.

14. The system of claim 8, wherein the at least one processor device determines an optimal lease period for a node based on a minimum number of optimal lease periods of the data.

15. A computer program product for providing a lease period determination by a processor device in a computing storage environment, the computer program product comprising a computer-readable storage medium having computer-readable program code portions stored therein, the computer-readable program code portions comprising:
a first executable portion that determines an optimal lease period of data for each one of a plurality of clients by a centralized entity by using at least one of a plurality of factors, wherein the plurality of factors include at least one of access characteristics of the data, historical access patterns of the data, a plurality of system configurations and policies; and
a second executable portion that sets the optimal lease period of the data for the one of the plurality of clients.

16. The computer program product of claim 15, further including a third executable portion that performs one of:
resetting the optimal lease period of the data for the one of the plurality of clients, and
using a combination of the plurality of factors for determining the optimal lease period of the data of the data.

17. The computer program product of claim 15, further including a third executable portion that performs one of:
determining whether the historical access patterns of the data is one of frequently accessed and infrequently accessed, and
determining whether the historical access patterns of the data is one of read only access and read and write access for each determination of whether the historical access patterns of the data is one of frequently accessed and infrequently accessed.

18. The computer program product of claim 15, further including a third executable portion that performs one of:
using service level agreements (SLAs) in the plurality of system configurations and policies,
determining whether a system configuration is one of a sharing configuration and a non-sharing configuration for including in the plurality of system configurations and policies, and
determining the system configuration is one of the sharing configuration and the non-sharing configuration based on a number of invalidates and a frequency of invalidates.

19. The computer program product of claim 15, further including a third executable portion that performs one of:
setting the optimal lease period of the data to be a longer lease period if the plurality of factors indicate that the historical access patterns of the data is frequently accessed and read only, and the plurality of system configurations and policies indicate a non-sharing configuration, wherein the longer lease period is a predetermined lease time,
setting the optimal lease period of the data to be the longer lease period if the plurality of factors indicate that the historical access patterns of the data is frequently accessed and read and write access, and the plurality of system configurations and policies indicate the non-sharing configuration,
setting the optimal lease period of the data to be the longer lease period if the plurality of factors indicate that the historical access patterns of the data is frequently accessed and read only access, and the plurality of system configurations and policies indicate a sharing configuration,
setting the optimal lease period of the data to be a shorter lease period if the plurality of factors indicate that the historical access patterns of the data is frequently accessed and the read and write access, and the plurality of system configurations and policies indicate the sharing configuration, wherein the shorter lease period is a predetermined lease time that is less than the longer lease time,
setting the optimal lease period of the data to be the longer lease period if the plurality of factors indicate that the historical access patterns of the data is infrequently accessed and the read only access, and the plurality of system configurations and policies indicate the non-sharing configuration, wherein the longer lease period is a predetermined lease time,
setting the optimal lease period of the data to be the longer lease period if the plurality of factors indicate that the historical access patterns of the data is the infrequently accessed and the read and write access, and the plurality of system configurations and policies indicate the non-sharing configuration,
setting the optimal lease period of the data to be the longer lease period if the plurality of factors indicate that the historical access patterns of the data is the infrequently accessed and the read only access, and the plurality of system configurations and policies indicate the sharing configuration, and
setting the optimal lease period of the data to be a shorter lease period if the plurality of factors indicate that the historical access patterns of the data is the infrequently accessed and the read and write access, and the plurality of system configurations and policies indicate the sharing configuration.

20. The computer program product of claim 15, further including a third executable portion that performs one of:
adjusting the optimal lease period of the data for each one of a plurality of clients based on a change to the at least one of the plurality of factors,
adjusting on the fly to the optimal lease period for each one of the plurality of clients, and
determines an optimal lease period for a node based on a minimum number of optimal lease periods of the data.
